(19) United States
(12) Patent Application Publication
(10) Pub. No.: US 2009/0005964 A1
(43) Pub. Date: Jan. 1, 2009

(54) Intelligent Route Guidance

(75) Inventors: Scott Forstall, Mountain View, CA (US); Gregory N. Christie, San Jose, CA (US); Robert E. Borchers, Pleasanton, CA (US); Kevin Tiene, Cupertino, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/020,073

(22) Filed: Jan. 25, 2008

Related U.S. Application Data
(60) Provisional application No. 60/946,827, filed on Jun. 28, 2007.

(51) Int. Cl. G01C 21/34; G01C 21/16; G01S 5/00

(52) U.S. Cl. 701/201; 701/209

(57) ABSTRACT

Intelligent route guidance can include deriving one or more routes based on traffic, historical data and/or preference data associated with route progressions implicated by the one or more routes. The route guidance can provide one or more recommended routes, which can be presented to a user for navigation purposes.

### CROSS-REFERENCE TO RELATED APPLICATION

This application claims priority to U.S. Provisional Patent Application Ser. No. 60/946,827 filed Jun. 28, 2007, and entitled “INTELLIGENT ROUTE GUIDANCE” the contents of which are incorporated herein by reference.

### BACKGROUND

This disclosure relates to navigation using a mobile device.

Navigation systems have begun to include functionality for inclusion of traffic data overlaying a navigation interface. Such navigation systems, however, provide little intelligence other than the ability to navigate from an origination point to a destination point. Because users often have some intelligence about routes to a location, in many instances users ignore navigation routes provided by the navigation system in favor of the routes the user knows. Additionally, current navigation systems do not readily facilitate navigation to a destination if a user desires to travel a different route while enroute on the route recommended by the navigation system.

### SUMMARY

In one aspect, systems, methods, apparatuses and computer program products are provided. In one aspect, methods are disclosed, which comprise: identifying destination information associated with a user; identifying one or more routes comprising a plurality of route progressions based on a current location and the destination information; retrieving route information associated with the plurality of route progressions, the route information comprising user preferences among the plurality of route progressions and traffic information associated with the plurality of route progressions; analyzing the plurality of route progressions based on the route information; and, presenting one or more routes to the user based on the analysis.

Systems can include a destination engine, a routing engine, an analysis engine and a presentation engine. The destination engine can receive destination information. The routing engine can identify routes comprising one or more route progressions based on a current location and the destination information. The routing engine can also retrieve route information associated with the route progressions, the route information including historical information associated with the plurality of route progressions and traffic information. The analysis engine can analyze the route progressions based upon the route information, and the presentation engine can present one or more routes to the user based on the results of the analysis engine.

Systems and methods as described can facilitate navigation of roads by directing a user to avoid traffic. Route guidance can also provide routes based on preference information associated with the user, thereby providing the user with a more enjoyable navigation. In some implementations, traffic updates can be received from peer devices through a server thereby providing more accurate traffic information for route guidance.

### BRIEF DESCRIPTION OF THE DRAWINGS

FIG. 1 is a block diagram of an example mobile device.

FIG. 2 is a block diagram of an example network operating environment for the mobile device of FIG. 1.

FIG. 3 is a block diagram of an example implementation of the mobile device of FIG. 1.

FIG. 4A is a block diagram illustrating an example system for processing routing instructions.

FIG. 4B is a block diagram of a plurality of route progressions.

FIG. 5 is a flowchart illustrating an example method for routing.

FIG. 6 is a flowchart illustrating another example method for routing.

FIG. 7 is a flowchart illustrating another example method for routing.

### DETAILED DESCRIPTION

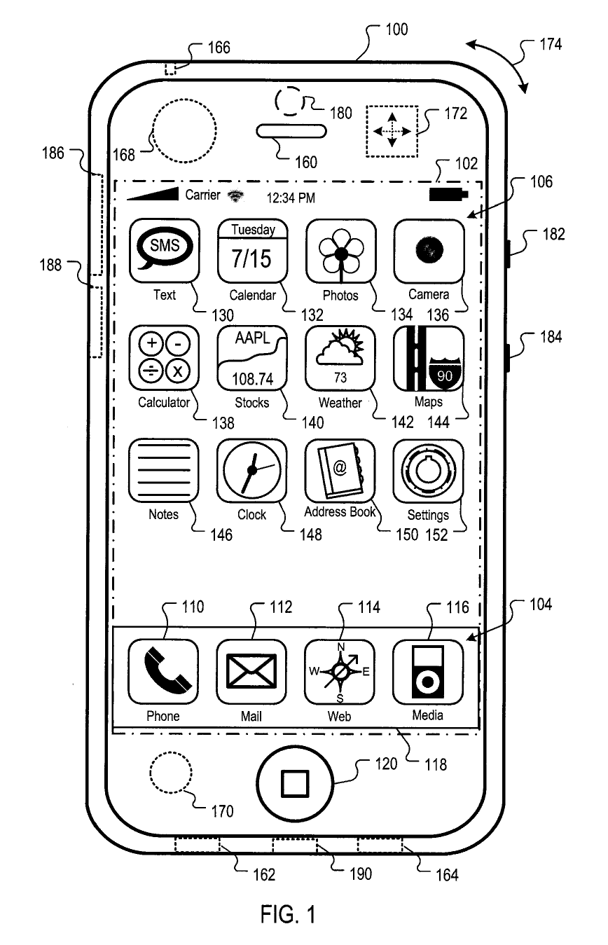

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or other device or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and U.S. Patent Publication 2002/0015024A1, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular display objects 104, e.g., the phone object 110, the e-mail object 112, the Web object 114, and the media player object 116, can be displayed in a menu bar 118. In some implementations, device functionalities can be accessed from a top-level graphical user interface, such as the graphical user interface illustrated in FIG. 1. Touching one of the objects 110, 112, 114 or 116 can, for example, invoke corresponding functionality.

In some implementations, the mobile device 100 can implement network distribution functionality. For example, the functionality can enable the user to take the mobile device 100 and its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state of FIG. 1 can be restored by pressing a button 120 located near the bottom of the mobile device 100. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 132, 134, 136, 138, 140, 142, 144, 146, 148, 150 and 152 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as a 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol. In some implementations, a TCP/IP over USB protocol can be used.

### Network Operating Environment

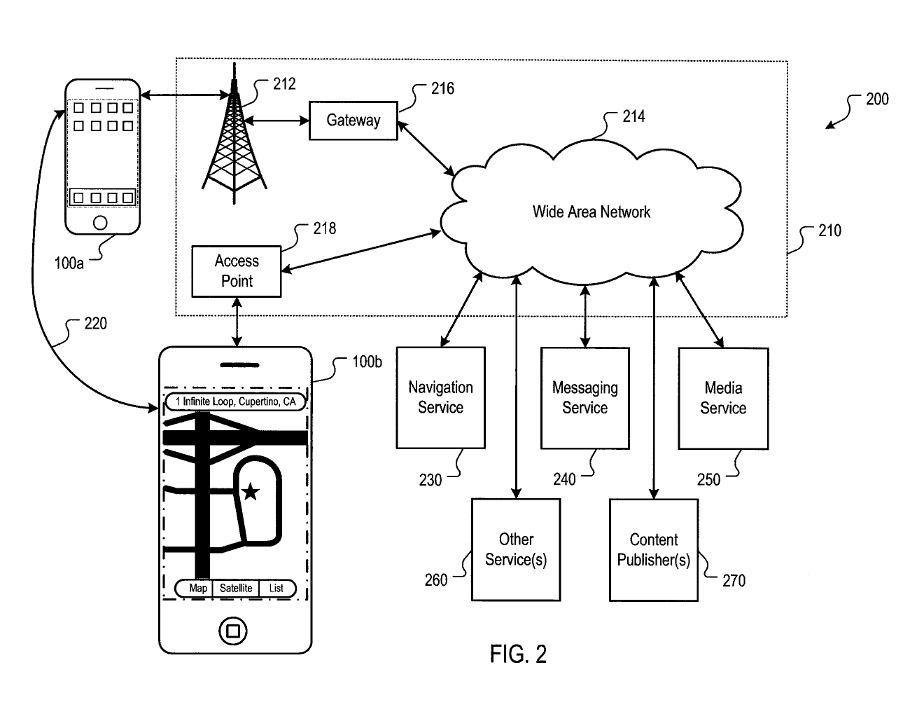

FIG. 2 is a block diagram of an example network operating environment 200 for the mobile device 100 of FIG. 1. The mobile device 100 of FIG. 1 can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access point device 218, such as an 802.11g wireless access point device, can provide communication access to the wide area network 214. In some implementations, both voice and data communications can be established over the wireless network 212 and the access point device 218. For example, the mobile device 100a can place and receive phone calls (e.g., using VoIP protocols), send and receive e-mail messages (e.g., using POP3 protocol), and retrieve electronic documents and/or streams, such as web pages, photographs, and videos, over the wireless network 212, gateway 216, and wide area network 214 (e.g., using TCP/IP or UDP protocols). Likewise, the mobile device 100b can place and receive phone calls, send and receive e-mail messages, and retrieve electronic documents over the access point device 218 and the wide area network 214. In some implementations, the mobile device 100 can be physically connected to the access point device 218 using one or more cables and the access point device 218 can be a personal computer. In this configuration, the mobile device 100 can be referred to as a “tethered” device.

The mobile devices 100a and 100b can also establish communications by other means. For example, the wireless device 100a can communicate with other wireless devices, e.g., other wireless devices 100, cell phones, etc., over the wireless network 212. Likewise, the mobile devices 100a and 100b can establish peer-to-peer communications 220, e.g., a personal area network, by use of one or more communication subsystems, such as the Bluetooth™ communication device 188 shown in FIG. 1. Other communication protocols and topologies can also be implemented.

The mobile device 100 can, for example, communicate with one or more services 230, 240, 250, and 260 and/or one or more content publishers 270 over the one or more wired and/or wireless networks 210. For example, a navigation service 230 can provide navigation information, e.g., map information, location information, route information, and other information, to the mobile device 100. In the example shown, a user of the mobile device 100b has invoked a map functionality, e.g., by pressing the maps object 144 on the top-level graphical user interface shown in FIG. 1, and has requested and received a map for the location “1 Infinite Loop, Cupertino, Calif.”

A messaging service 240 can, for example, provide e-mail and/or other messaging services. A media service 250 can, for example, provide access to media files, such as song files, movie files, video clips, and other media data. One or more other services 260 can also be utilized by the mobile device 100.

The mobile device 100 can also access other data and content over the one or more wired and/or wireless networks 210. For example, content publishers 270, such as news sites, RSS feeds, web sites, blogs, social networking sites, developer networks, etc., can be accessed by the mobile device 100. Such access can be provided by invocation of a web browsing function or application (e.g., a browser) in response to a user touching the Web object 114.

### Example Mobile Device Architecture

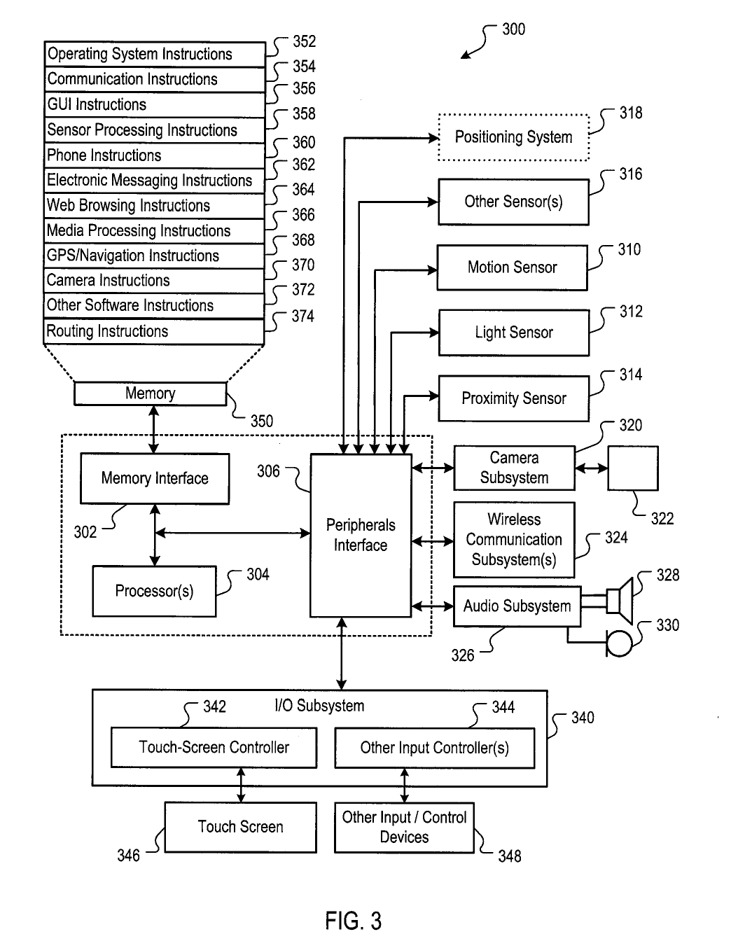

FIG. 3 is a block diagram 300 of an example implementation of the mobile device 100 of FIG. 1. The mobile device 100 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device 100 can be coupled by one or more communication buses or signal lines.

Sensors, devices and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting and proximity functions described with respect to FIG. 1. Other sensors 316 can also be connected to the peripherals interface 306, such as a positioning system (e.g., GPS receiver), a temperature sensor, a biometric sensor, or other sensing device, to facilitate related functionalities.

In some implementations, the mobile device can receive positioning information from a positioning system 318. The positioning system 318, in various implementations, can be located on the mobile device, or can be coupled to the mobile device (e.g., using a wired connection or a wireless connection). In some implementations, the positioning system 318 can include a global positioning system (GPS) receiver and a positioning engine operable to derive positioning information from received GPS satellite signals. In other implementations, the positioning system 318 can include a compass and an accelerometer, as well as a positioning engine operable to derive positioning information based on dead reckoning techniques. In still further implementations, the positioning system 318 can use wireless signals (e.g., cellular signals, IEEE 802.11 signals, etc) to determine location information associated with the mobile device, such as those provided by Skyhook Wireless, Inc. of Boston, Mass. Hybrid positioning systems using a combination of satellite and television signals, such as those provided by Rosum Corporation of Mountain View, Calif., can also be used. Other positioning systems are possible.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 is intended to operate. For example, a mobile device 100 may include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the device 100 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device 100 on or off. The user may be able to customize a functionality of one or more of the buttons. The touch screen 346 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod. Other input/output and control devices can also be used.

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions.

In some implementations, the mobile device can also include routing instructions 374. The routing instructions can be used to provide navigation guidance to a user of the mobile device. In such implementations, the routing instructions can provide intelligent routing based on traffic, user preferences, and/or history.

Each of the above identified instructions and applications can correspond to a set of instructions for performing one or more functions described above. These instructions need not be implemented as separate software programs, procedures or modules. The memory 350 can include additional instructions or fewer instructions. Furthermore, various functions of the mobile device 100 may be implemented in hardware and/or in software, including in one or more signal processing and/or application specific integrated circuits.

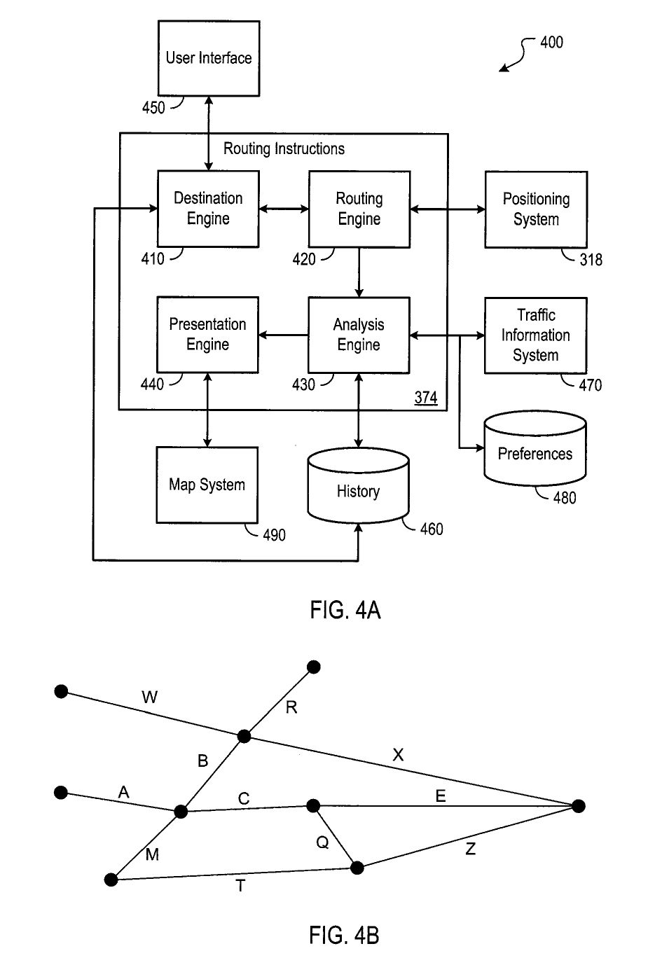

FIG. 4A is a block diagram illustrating an example system 400 for processing routing instructions. The system 400, for example, can use traffic information in combination with preference information to provide routing information to a user. In other implementations, the system can provide traffic updates based on information collected from peer devices. In further implementations, the system can identify patterns in historical data and predict traffic and/or destination information.

In some implementations, the routing instructions, when executed, can implement a destination engine 410, a routing engine 420, an analysis engine 430 and a presentation engine 440. In an implementation, the destination engine 410 can receive destination information from a user interface 450. In various implementations, the user interface can include a graphical user interface such as could be provided by the GUI instructions and touch screen of FIG. 3.

In other implementations, the destination engine 410 can derive destination information based on historical data retrieved, for example, from a historical data store 460. The destination engine 410 can parse the historical data to derive navigation habits. For example, a user might drive to work every day. Thus, the destination engine 410 can determine that there is a probability that a destination associated with the user is a workplace. In other implementations, the destination engine 410 can use any other algorithm to derive a destination, including, for example, a Markov chain based algorithm. In various examples, the derived destination can include multiple destinations. In such examples, the destinations can include one or more waypoints along with a final destination. In other examples, the derived destination can also take into account a parking situation associated with a destination. Thus, if a user is headed for a stadium for a sporting event, the destination engine 410 can determine that while the stadium is the ultimate destination, the user might be directed to a parking lot as a waypoint to park his/her car before going to the stadium.

In some implementations, the destination engine 410 utilizes date information, time information, calendar information, history information, preference information, etc. to derive destination information. Date information can include, for example, the day of the week, holiday information, etc. For example, a user might have a history of navigating to/from work on Monday through Friday, navigating to/from a grocery store on Sundays, navigating to a parent's house on Mother's Day or Father's Day, etc.

In some implementations, the destination engine 410 can also use the time information such as, e.g., the time of day to derive a destination. For example, on Monday morning, it is likely that a user is navigating to work, on Wednesday night it is likely that the user is navigating to a softball field for a regularly scheduled game, etc.

In some implementations, the destination engine 410 can use calendar information such as appointments, tasks, etc. to derive destination information. For example, a user might have a calendar entry indicating a court date on Aug. 23, 2007 at 9:00 AM, and thus it is likely that on Aug. 23, 2007 at 8:30 am, the user is navigating to a courthouse.

In some implementations, the destination engine 410 can use history information to recognize patterns, and can use preference information to determine which of a plurality of destinations the user intends (e.g., a user might indicate a preference for destination information derived from calendar information over destination information derived from date information). In some implementations, the destination engine 410 can automatically recognize patterns without user input. In other implementations, the destination engine 410 can automatically recognize navigation patterns and allow users to confirm or reject a destination through a user interface.

In some implementations, the routing engine 420 can derive one or more routes based on current location information and destination information. The one or more routes can be derived using existing routing technology, e.g., map overlays. Current location information of the user can be obtained, for example, using a positioning system 318. In various implementations, the positioning system 318 can be provided by a separate device coupled to the mobile device (e.g., mobile device 100 of FIG. 1). In other implementations, the positioning system 318 can be provided internal to the mobile device.

In one implementation, the positioning system 318 can be a global positioning system (GPS) device. In other implementations, the positioning system 318 can be provided by an accelerometer and a compass using dead reckoning techniques. In such implementations, the user can occasionally reset the positioning system 318 by marking the device's presence at a known location (e.g., landmark, intersection, etc.). In still further implementations, the positioning system 318 can be provided by using wireless signal strength and one or more locations of known wireless signal sources to provide current location. Wireless signal sources can include access points and/or cellular towers. Other positioning systems can also be used.

The routing engine 420 can communicate one or more derived routes to an analysis engine 430. The analysis engine 430 can analyze the one or more routes received from the routing engine 420. In some implementations, the one or more routes can be analyzed based on traffic information received from a traffic information system 470. Based on the complexity of a route, the route can include many route progressions. Route progressions, in some implementations, can include a discrete length of road which comprises a route.

In some implementations, the traffic information can be retrieved based upon the route progressions associated with the one or more routes. For example, FIG. 4B is a block diagram of a plurality of route progressions. In the example of FIG. 4B, a first route includes progressions A, B and X, a second route includes progressions A, C, Q and Z, and a third route includes progressions A, C and E. However, route progressions M, T, R and W are not included in any of the routes. In one implementation, the analysis engine 430 can send a request for traffic information associated with only route progressions A, B, C, E, Q, X and Z to the traffic information system 470, while omitting route progressions M, T, R and W because those route progressions are not included in any of the identified routes.

In other implementations, the traffic information sent to a mobile device (e.g., mobile devices 100 of FIG. 1) can include a universe of traffic information including all available traffic information related to local roads. In such implementations the traffic signal can include many component parts (e.g., one for each available road), and the traffic information for the various roads can be encoded into the signal (e.g., using time division, code division, frequency division, etc.). Thus, the analysis engine 430 can parse (e.g., decode, demultiplex, etc.) the signal to obtain traffic information for a desired route progression. Thus, the mobile device might receive traffic information associated with route progressions A through Z (e.g., A, B, C, E, M, R, T, W, Q, X and Z). Based on the previous example, the analysis engine 430 can parse the traffic information to retrieve traffic related to route progressions A, B, C, E, Q, X and Z.

In some implementations, the one or more routes can be analyzed based upon user preferences retrieved from a preference data store 480. User preference data, for example, can indicate a user preference for types of roads, distance, traffic, traffic control devices (e.g., traffic lights, stop signs, rotaries, etc.), time, preferred routes, neighborhoods, simplicity of the route (e.g., least number of turns), etc. In some implementations, the analysis engine can use such preferences to select among the one or more routes provided by the routing engine. In other implementations, the preference store can include groups of preferences, for example, based upon the user or based upon a vehicle being used to navigate the route.

In some implementations the analysis engine 430 can send reminders to a user for an appointment time based upon the expected navigation time (e.g., based upon traffic information, distance information, speed limit information, etc.) associated with a preferred route. For example, if the user has an appointment across 5 miles away, the analysis engine can analyze the routes and determine the time that it would take the user to navigate to the destination and send a reminder to the user to begin heading for the appointment based upon the estimated navigation time associated with the destination.

In further implementations, the analysis engine 430 can analyze one or more routes based upon historical data. For example, historical data can include information about the average time associated with navigating a route progression. The average time associated with a number of route progressions included in a route can be combined to provide an estimated total time to navigate the route. The route may then be compared to similarly analyzed routes based on estimated total time to navigate the other routes, which can be used to recommend a route to a user.

In some implementations, the average time to navigate a route progression can be dependent upon the time of day the route progression is being navigated. For example, a section of highway in a large city may be slow at 8:00 am due to rush hour, while the same section of highway might be clear at 10:00 pm. Thus, the historical data can include a time of day for which the average is to be computed. For example, the analysis engine 430 can average the five navigations taken at the closest times of day to a current time and/or a future time at which the analysis engine would expect a user to be on a given route progression. In further implementations, recency of a navigation can be factored in to the estimation of navigation time. For example, the five most recent navigations of a road may be used to calculate an estimated navigation time associated with the route progression. In other implementations, any of these factors can be combined. For example, the time of day can be balanced with the recency of a navigation to produce the five most recent navigations which are closest in time of day to a current time of day.

In further implementations, current traffic information or historical information can be used to derive a time associated with the user's navigation of a current route progression. For example, if a user is navigating a heavy traffic area, the traffic information can be used to determine when the user will be navigating the next route progression, and that determination can be used to determine a time period during which to predict route information associated with the next route progression.

In some implementations, the device can retrieve advisories associated with route progressions the user will be navigating in the future based upon the time during which the user will be navigating the route progression. For example, a department of transportation website can include time dependent advisories (e.g., heavy fog expected between specified hours in a certain area or lane closures between certain hours). In other examples, local sporting events that might effect traffic in a proximate area can be identified and used in identifying information which can affect the desirability of navigating an affected route progression.

The analysis engine 430 can provide one or more recommended routes to a presentation engine 440. The presentation engine can communicate with a map system 490. In some implementations, the map system can be provided, for example, by a navigation service (e.g., navigation service 230 of FIG. 2). In other implementations, the map system 490 can be provided by a map store residing on the mobile device (e.g., mobile device 100 of FIG. 1). The presentation engine 440 can use the map provided by the map system 490 to overlay the route information. In examples where multiple routes are provided to the user, the presentation engine can receive a route preference from the user and display the preferred route.

In some implementations, the routing instructions can continue to analyze a current route to monitor for changing conditions. For example, an accident between the start of navigation of a route and the end of navigation of the route can change the analysis associated with recommending the current route. In such situations, the routing engine 420 and analysis engine 430 can calculate estimated navigation times associated with alternative routes. In some implementations, the routing engine 420 and analysis engine 430 can automatically communicate a new route to the user through the presentation engine 440. Such automatic rerouting can be provided to the user with notification of the change or without notification of the change to the user. In other implementations, the routing engine 420 and analysis engine 430 can present the estimated navigation times associated with alternative routes to the user through the presentation engine 440. The user can then choose an alternative route based upon the estimated navigation times. The user's choice, in various implementations, can be indicated by selecting a route using an I/O device (e.g., touch screen 346 of FIG. 3), or by navigating one of the alternative routes, among others.

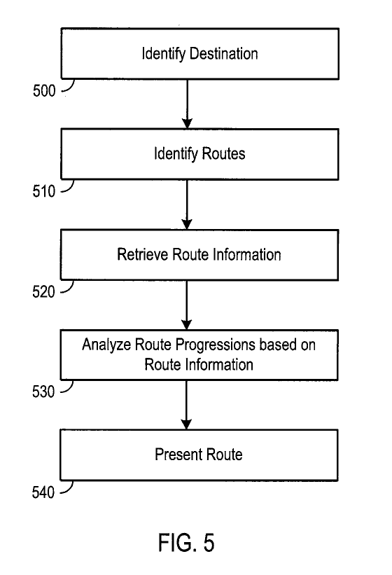

FIG. 5 is a flowchart illustrating an example method for route guidance. At stage 500 the destination is received/identified. The destination can be identified, for example, by a destination engine (e.g., destination engine 410 of FIG. 4). In some implementations, the destination engine can operate based on user input received using a user interface (e.g., user interface 450 of FIG. 4). In such implementations, the user can provide destination information to a mobile device (e.g., mobile device 100 of FIG. 1). In other implementations, the destination engine can operate based on historical data retrieved from a history data store (e.g., history data store 460 of FIG. 4). For example, the destination engine can mine the historical data to automatically derive navigation patterns based on such variables as day, time of day, holiday, and user calendar, among many others. In still further examples, the destination engine can identify destination information based on a combination of user input and historical information. For example, the destination engine can use the user interface to prompt the user to select a destination from among a group of destinations derived based on the historical data.

At stage 510, routes associated with the destination are identified. The routes can be identified, for example, using a routing engine (e.g., routing engine 420). In some implementations, the routing engine can receive position information from a positioning system (e.g., positioning system 318 of FIG. 4). The position information can be used as a starting point for the routing engine. In some implementations, the routing engine can use a navigation service (e.g., navigation service 230 of FIG. 2) to derive one or more routes. In other implementations, the routing engine can use GPS/navigation instructions 368 to derive one or more routes.

At stage 520, route information is retrieved. Route information can be retrieved, for example, using an analysis engine (e.g., analysis engine 430 of FIG. 4). In various implementations, the routing information can include, for example, any of traffic information, user preferences, historical data, or combinations thereof. The traffic information can be retrieved, for example, from a traffic information service (e.g., traffic information system 470). In some implementations, the traffic information service can be provided by a government or commercial service provider.

In other implementations, the traffic information service can be provided by peer devices. In such implementations, peer device can automatically upload sequential positioning data to a server. In some of these implementations, the peer device can derive speed based on sequential positioning data and elapsed time. In other implementations, a server can process sequential positioning data received from the device based on the time between a first position and a second position and derive a distance between the positions and a time elapsed to travel that distance. Such distance and time derivations enable the server to derive a speed associated with the device, and thereby associated with a stretch of road the device has just traveled. The server can then provide, e.g., by a push or pull operation, the route information to any mobile devices within a defined proximity (e.g., user defined, system defined, etc.), and/or to any mobile devices navigating a route that includes the route progression implicated by the sequential positioning data. For example, the server can provide the route progression and speed information associated with that route progression to such devices. Alternatively, the actual peer device sequential positioning data can be provided to any mobile devices within a defined proximity, and/or to any mobile devices having a current route that includes a route progression implicated by the sequential positioning data provided by the peer devices. The mobile devices can thereby analyze the sequential positioning data from each of the peer devices providing sequential positioning data and can determine a speed associated with a particular route progression.

The user preferences can be retrieved, for example, from a preference data store (e.g., preference data store 480 of FIG. 4). The user preferences can include, for example, preferences for shortest timed routes, shortest distance routes, preferred routes, preferred neighborhoods, fewest traffic lights, reliability (e.g., low standard deviation in previous navigation times), etc. Other preferences can be provided.

The historical data can be retrieved, for example, from a historical data store (e.g., historical data store 460 of FIG. 4). Historical data can include, for example, previously traveled routes, navigation times linked with those routes, time of day linked to the navigation times, etc. In some implementations, the traffic information system uses historical data to estimate traffic information based on historical data including route progression identification, navigation time, and time of day the route was navigated. Using such historical data can be derived, for example, that the average time for a particular route progression is 10 minutes with a standard deviation of 2 minutes.

At stage 530, the route is analyzed based on route information. The route can be analyzed, for example, using an analysis engine (e.g., analysis engine 430 of FIG. 4). The analysis includes the route information previously retrieved. In some implementations, the analysis can receive several different routes and prioritize the routes based on the route information.

At stage 540, a route is presented. The route can be presented, for example, by a presentation engine (e.g., presentation engine 440) to a user of a mobile device. The presented route can be overlaid onto a map provided by a navigation system (e.g., map system 490 of FIG. 4, or navigation services 230 of FIG. 2). In other implementations, the route can be overlaid on a map provided by a local map data store. In some implementations, the map includes a number of road representations. The road representations, for example, can be overlaid by traffic information associated with respective route progressions. Traffic information can be indicated, for example, by color coding on or alongside road representations, pushpin messages associated with road representations, traffic animations associated with road representation, etc. The presentation of the route can enable a user of the mobile device to navigate from a current position to a destination.

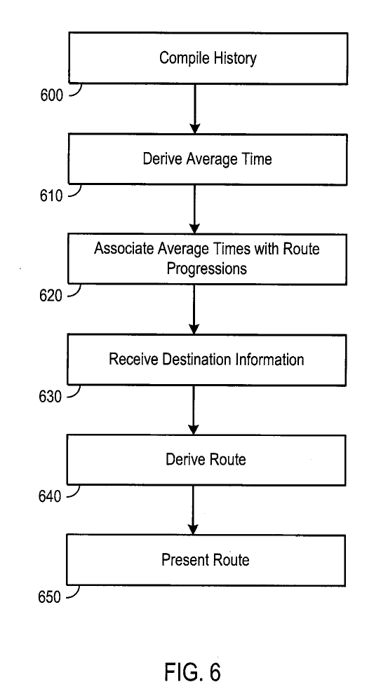

FIG. 6 is a flowchart illustrating another example method for route guidance. At stage 600, a history is compiled. The history can be compiled, for example, by a history data store (e.g., history data store 460 of FIG. 4), in conjunction with a positioning system (e.g., positioning system 318 of FIG. 4). In some implementations, the historical data can include timing data associated with a route or subsets of the route, such as could be provided by a timing device (e.g., a device clock). Historical data can also include distance information associated with a route or subset of the route and can be reflected in absolute distance and/or actual distance. For example, the absolute distance (e.g., straight line distance) between two points may be two miles. However, navigating between the same two points using a system of roads can involve navigating three miles of roads. In various implementations, route progressions can include a plurality of scales. For example, on one scale, a route progression might include a segment of road between intersections. On another scale, a route progression might include a segment of road between major intersections (e.g., intersections controlled by traffic control devices). On yet another scale, route progressions might include multiple roads between common waypoints (e.g., common intersections or common start or destination points). Use of other scales as well as use of combinations of multiple scales is possible.

At stage 610, an average time associated with a route progression can be derived. The average time can be derived for example by an analysis engine (e.g., analysis engine 430 of FIG. 4). In one implementation, the average time associated with a route progression can be derived by aggregating the navigation times associated with each of a plurality of route progressions and dividing the aggregated time by the total number of navigations associated with the route progression. In another implementation, a moving average can be derived based on the most recent trips. In still further implementations, the average time associated with a route progression, can also be based upon a time of day and/or day of the week associated with the navigation of the route progression. Thus, trips between 7:00 AM and 9:00 AM on non-holiday weekdays can be grouped together to provide an average rush hour navigation time associated with a route progression, while non-peak traffic times can be grouped together to provide an average non-rush hour navigation time associated with the route progression.

At stage 620, average times are associated with route progressions. The average times can be associated with route progressions, for example, by an analysis engine (e.g., analysis engine 430 of FIG. 4) in conjunction with a history data store (e.g., history data store 460 of FIG. 4). Thus, in some implementations, an average time can be linked to a route progression. In further implementations, multiple average navigation times can be linked to a route progression. The multiple average times can be linked to a route progression to provide categories associated with the average times. For example, the average time could be categorized as daytime non-rush hour, morning rush hour, evening rush hour, evening non-rush hour, night time, and/or holiday. Other categorizations of navigation times are possible.

At stage 630, destination information is received/identified. The destination information can be received, for example, using a destination engine (e.g., destination engine 410 of FIG. 4) in conjunction with a user interface (e.g., user interface 450 of FIG. 4). In some implementations, the destination can include address information identifying a destination and can be received through a touch screen 346.

At stage 640, a route can be derived based on average times associated with the route progressions. The route can be derived, for example, by a routing engine (e.g., routing engine 420 of FIG. 4) in conjunction with an analysis engine (e.g., analysis engine 430 of FIG. 4). The route can be derived based on a current location (e.g., obtained from a positioning system 318 of FIG. 3) and based on the destination information, the shortest route can be derived based on the average time associated with the route progressions. In other implementations, the route can be derived based on average time associated with route progressions as well as user preferences for route progressions.

At stage 650, a route is presented. The route can be presented, for example, by a presentation engine (e.g., presentation engine 440) to a user of a mobile device. In various implementations, the route can be presented in a variety of ways, including those discussed with reference to FIG. 5.

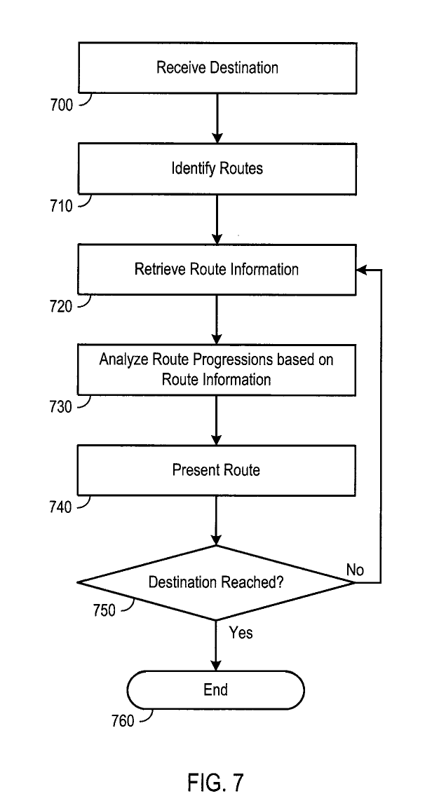

FIG. 7 is a flowchart illustrating another example method for route guidance. At stage 700 the destination is received/identified. The destination can be received, for example, by a destination engine (e.g., destination engine 410 of FIG. 4). In various implementations, the destination engine can operate based on user input received using a user interface (e.g., user interface 450 of FIG. 4), or can automatically derive a destination based on historical data, and combinations thereof.

At stage 710, routes associated with the destination are identified. The routes can be identified, for example, using a routing engine (e.g., routing engine 420). In some implementations, the routing engine can receive position information from a positioning system (e.g., positioning system 318 of FIG. 4). The positioning information can be used as a starting point for the routing engine, and the routing engine can use a navigation service (e.g., navigation service 230 of FIG. 2) to derive one or more routes. In other implementations, the routing engine can use GPS/navigation instructions 368 to derive one or more routes.

At stage 720, route information is retrieved. Route information can be retrieved, for example, using an analysis engine (e.g., analysis engine 430 of FIG. 4). In various implementations, the routing information can include, for example, any of traffic information, user preferences, historical data, or combinations thereof. In one implementation, traffic information can be provided, for example, by a traffic information system (e.g., traffic information system 470 of FIG. 4). User preferences can be retrieved, for example, from a preference data store (e.g., preference data store 480). Historical data can be retrieved, for example, by a history data store (e.g., history data store 460 of FIG. 4).

At stage 730, the route is analyzed based on route information. The route can be analyzed, for example, using an analysis engine (e.g., analysis engine 430 of FIG. 4). The analysis includes the route information previously retrieved. In some implementations, the analysis can receive several different routes and prioritize the routes based on the route information.

At stage 740, a route is presented. The route can be presented, for example, by a presentation engine (e.g., presentation engine 440) to a user of a mobile device. The route can be presented in any of the ways discussed with reference to FIGS. 4-6.

At stage 750, a determination can be made whether a destination has been reached. The determination can be made, for example, by an analysis engine (e.g., analysis engine 430 of FIG. 4) in conjunction with a positioning system (e.g., positioning system 318 of FIG. 4). Where the destination has been reached, the process ends at stage 760.

If the destination has not been reached, the method can return to stage 720, where new route information is retrieved. The new route information is then analyzed, and one or more alternative routes are presented to a user based on changing route information (e.g., an accident, traffic build-up, traffic clearing up, etc.). Thus, a mobile device (e.g., mobile device 100 of FIG. 1) can reroute the user based on changing road conditions. In some implementations, an alternative route is automatically presented to the user without notification, and replaces the current route. In other implementations, a user can be notified that another route might be preferable, and the estimated navigation times associated with both routes can be compared and the user can decide whether to continue on a current route, or to take an alternative route.

The systems and methods disclosed herein may use data signals conveyed using networks (e.g., local area network, wide area network, internet, etc.), fiber optic medium, carrier waves, wireless networks (e.g., wireless local area networks, wireless metropolitan area networks, cellular networks, etc.), etc. for communication with one or more data processing devices (e.g., mobile devices). The data signals can carry any or all of the data disclosed herein that is provided to or from a device.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

1. A method comprising:
identifying destination information associated with a mobile device;
identifying one or more routes comprising a plurality of route progressions based on a current location of the mobile device and the destination information;
retrieving route information associated with the plurality of route progressions, the route information comprising user preferences and traffic information associated with the plurality of route progressions;
analyzing the plurality of route progressions based on the route information; and
presenting one or more routes to the user based on the analysis.

2. The method of claim 1, further comprising providing an estimated time associated with the one or more routes presented to the user, the estimated time being based on traffic information.

3. The method of claim 1, further comprising:
receiving positioning data from a plurality of peer devices; and
deriving traffic information based on the received peer device positioning data.

4. The method of claim 1, further comprising:
receiving a plurality of preferences from the user; and
analyzing the plurality of route progressions based on the route information and the plurality of preferences.

5. The method of claim 1, further comprising providing the method in a multi-touch environment.

6. The method of claim 1, wherein the destination information is identified based upon user input.

7. The method of claim 1, wherein the destination information is identified based on historical navigation information.

8. The method of claim 1, further comprising:
receiving updated route information during navigation of a route, the updated route information being associated with a plurality of route progressions between a current position and a destination identified by the destination information; and
providing one or more alternative routes during navigation based on the updated route information.

9. The method of claim 8, wherein providing one or more alternative routes during navigation based on the updated route information comprises providing an estimated time associated with each of the one or more alternative routes.

10. The method of claim 9, wherein the estimated time is based on traffic information.

11. The method of claim 1, further comprising:
retrieving user history data associated with navigation of each route progression comprising the one or more routes, wherein the user history data includes a history of each time a particular route progression is navigated, a navigation time respectively associated with each navigation of the particular route progression, and a time of day associated with each navigation of the particular route progression; and
deriving traffic information based on user history data.

12. The method of claim 1, wherein the traffic information is retrieved from one or more peer devices navigating the plurality of route progressions.

13. A system comprising:
a destination engine operable to receive destination information;
a routing engine operable to identify a plurality of routes, each route comprising a plurality of route progressions, the identification of the plurality of routes being based on a current location of a mobile device and the destination information, the routing engine being further operable to retrieve route information associated with the plurality of route progressions, the route information comprising historical information associated with the plurality of route progressions and traffic information;
an analysis engine operable to analyze the plurality of route progressions based upon the route information; and
a presentation engine operable to present one or more routes to a user of the mobile device based on the analysis.

14. The system of claim 13, wherein the presentation engine is further operable to provide an estimated time associated with the one or more routes presented to the user, the estimated time being based on one or more of historical information or traffic information.

15. The system of claim 14, further comprising a multi-touch screen operable to present the one or more routes to the user and to receive a selection of the one or more routes from the user.

16. The system of claim 13, further comprising:
a user interface operable to receive user input comprising a plurality of preferences from the user; and
wherein the analysis engine is operable to analyze the plurality of route progressions based on the route information and the plurality of preferences.

17. The system of claim 13, further comprising a user interface operable to receive destination information from the user using a multi-touch environment.

18. The system of claim 13, wherein the destination information is identified based on historical navigation information.

19. The system of claim 13, wherein the routing engine is further operable to retrieve updated route information during navigation of a route, the updated route information being associated with a plurality of route progressions between a current position and a destination identified by the destination information; and
wherein the presentation engine is further operable to present one or more alternative routes during navigation based on the updated route information.

20. The system of claim 19, wherein the presentation engine is further operable to provide an estimated time associated with each of the one or more alternative routes.

21. The system of claim 20, wherein the estimated time is based on traffic information.

22. The system of claim 13, wherein the traffic information is derived from history data retrieved from a history data store, the history data including a history of each time a particular route progression is navigated, a navigation time respectively associated with each navigation of the particular route progression, and a time of day associated with each navigation of the particular route progression.

23. The system of claim 13, wherein the traffic information is retrieved from one or more peer devices navigating the plurality of route progressions.

24. The system of claim 13, further comprising a positioning system operable to derive the current location, the current location operable to be used by the routing engine to derive the plurality of routes, and by the analysis engine to estimate a navigation time associated with the plurality of routes.

25. The system of claim 24, wherein the positioning system comprises an accelerometer and a compass and uses dead reckoning to derive a current position.

26. The system of claim 24, wherein the positioning system comprises a global positioning system operable to receive location signals from satellites and to derive a current position based on the location signals.

27. The system of claim 24, wherein the positioning system is operable to estimate a location based on proximity to one or more cellular towers, the proximity being derived based on signal strength associated with a signal received from the one or more cellular towers.

28. A computer-implemented method comprising:
storing a history comprising a plurality of routes navigated by a user, each of the plurality of routes comprising a plurality of route progressions, the history further comprising a plurality of measured times associated with each of the previous navigations of the route progressions;
deriving a plurality of time metrics respectively associated with each of the plurality of route progressions based on the plurality of measured times;
associating the time metrics with respective route progressions;
receiving destination information; and
presenting a recommended route based upon the average time associated with the plurality of route progressions comprising the recommended route.

29. The method of claim 28, wherein the time metrics comprises a moving average based upon a predetermined number of navigations of a respective route progression.

30. The method of claim 28, wherein the time metrics comprise a moving average based on a number of previous navigations within a predetermined time period of a respective route progression.

31. The method of claim 28, further comprising communicating the time metrics associated with the route progressions to a server, the server being operable to distribute an aggregation of the time metrics to other users.

32. The method of claim 28, further comprising receiving traffic updates from one or more peer devices, the traffic updates associated with the plurality of route progressions comprising the recommended route.

33. The method of claim 32, further comprising updating the recommended route based on traffic updates received from peer devices.

34. The method of claim 32, wherein the traffic updates from peer devices are received from a server operable to aggregate traffic information from a plurality of peer devices.

35. A method comprising:
identifying destination information associated with a mobile device;
identifying a plurality of potential routes, the potential routes comprising a plurality of route progressions and being based on a current location of the mobile device and the destination information;
receiving routing information associated with the plurality of route progressions, the routing information comprising:
user preferences; and
traffic information associated with the plurality of route progressions;
analyzing the potential routes based on the route information; and
communicating one or more recommended routes to the user based on the analysis.

36. A method for determining a route between a source and a destination, comprising:
identifying a destination associated with a mobile device;
deriving one or more prospective routes between a current location associated with the mobile device and the destination, the one or more potential routes comprising a plurality of prospective route progressions;
receiving peer navigation data from one or more peer devices that have navigated any of the plurality of prospective route progressions within a previous time period;
selecting a route from the one or more prospective routes based upon the peer navigation data.
